(19) United States
(12) Patent Application Publication
(10) Pub. No.: US 2006/0107000 A1
(43) Pub. Date: May 18, 2006

(54) Peer-based partitioning method for system resource sharing

(76) Inventors: Lee Jung-Ik, Tumwater, WA (US); Daniel G. Ketcham, Cupertino, CA (US); Ronald N. Hilton, Cupertino, CA (US)

Correspondence Address: KENYON & KENYON, Suite 600, 333 W. San Carlos Street, San Jose, CA, 95110-2711, US

(21) Appl. No.: 11/271,681

(22) Filed: Nov. 10, 2005

Related U.S. Application Data
(60) Provisional application No. 60/628,420, filed on Nov. 15, 2004.

(51) Int. Cl. G06F 12/00

(52) U.S. Cl. 711/153

(57) ABSTRACT

A method and system for partitioning a computer system into multiple virtual machines is disclosed. The system may include multiple logical partitions, each with their own set of physical resources controlled by a partition processor. The system may also include an external processor that maintains a map of what resources belong to what partitions. The logical partitions within the system may maintain a peer-to-peer relationship.

### BACKGROUND

The present invention relates to the virtual memory of a computer system and, in particular, to a peer-based partitioning method for system resource sharing.

The physical resources of a system can be divided into multiple logical partitions where each logical subset of the physical machine acts as a virtual machine. Partitioning of a computer system into multiple virtual machines is a well-established concept that was originally developed in an era when enterprise-class computer hardware was very expensive. Therefore, taking physical/logical resources and virtualizing them (i.e. creating separate virtual machines) were desirable so that the expensive hardware could be shared.

A layer of software, called a “hypervisor,” controls the interaction between the various virtual machines. Any time a virtual machine wants to access a shared, physical resource, it does so through the hypervisor. The hypervisor acts as a master-control program. Anytime a logical partition wants access to a physical resource, it must go through the hypervisor. The hypervisor has to monitor and be actively involved with each logical partition. While significant progress has been made in both software and hardware technology for reducing the overhead of partitioning, a hypervisor overhead of 10-15% is still typical. Reducing the 10-15% overhead is desirable.

### SUMMARY OF THE INVENTION

A method and system for partitioning a computer system into multiple virtual machines is disclosed. The system may include multiple logical partitions, each with their own set of physical resources controlled by a partition processor. The system may also include an external processor that maintains a map of what resources belong to what partitions. The logical partitions within the system may maintain a peer-to-peer relationship.

### BRIEF DESCRIPTION OF THE DRAWINGS

FIG. 1 is a diagram of a possible configuration of a computer system to execute the present invention.

FIG. 2 is a diagram of one embodiment of a partition resource map.

FIG. 3 is a flowchart one embodiment of a method of logically partitioning a computer system into multiple virtual machines.

### DETAILED DESCRIPTION

A method and system for logically partitioning a computer system into multiple virtual machines is disclosed. A set of physical resources of a computer system are partitioned into a set of logical partitions. A logical partition may contain one or more physical processors. One of the processors may be a controller of the partition. Each partition processor may then control its logical partition. The partitions may have a master slave configuration.

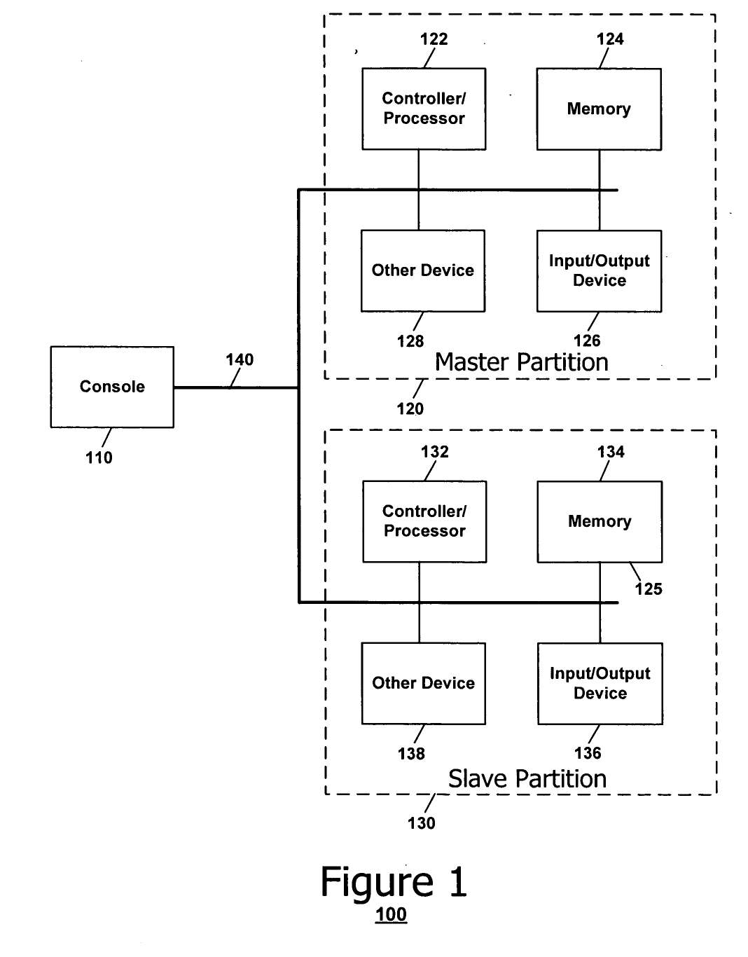

FIG. 1 illustrates a possible configuration of a computer system 100 to execute the present invention. The physical resources of the computer system 100 may be separated into a set of logical partitions. The computer system 100 may have an external processor called the console 110 to maintain a map of resources to the logical partitions. A partition controller may act as a console 110 or may control multiple partitions. One embodiment may have a master partition 120/slave partition 130 configuration. The master partition 120 and slave partition 130 may each have a set of physical resources, such as processors 122 and 132, memories 124 and 134, I/O cards/ports 126 and 136, and other devices 128 and 138. Partitions may not be configured symmetrically. For example, one partition may not have any I/O ports of its own, using another partition.

In a peer based system, each partition has its own domain of physical resources, accesses the resources directly, and communicates directly with other partitions rather than going through a hypervisor. The console 110 takes those physical resources and maps them to different logical partitions. The console 110 may be involved when a partition needs to access the physical resources of another partition. As long as system resources are not being redistributed from one partition to another, the console 110 need not be involved in the actual tasks being performed. Each partition may monitor itself.

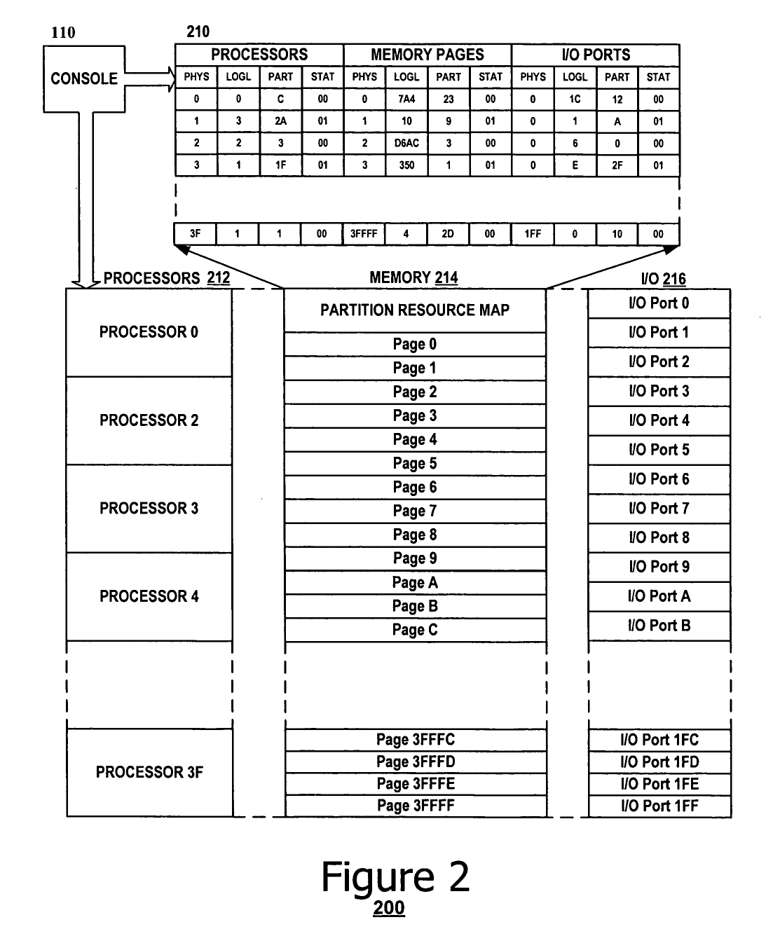

FIG. 2 illustrates in a block diagram one embodiment of a partition resource map stored in memory. A console 110 may use a partition resource map 210 to map physical components in a partitioned environment, and may use a partition resource map 210 to provide system management and configuration functionality. A partition resource map 210 may be used to map physical components such as processors 212, memory pages 214, and I/O ports 216 among the various partitions by listing a logical and physical partition for each physical resource. A partition resource map may further be used for monitoring the reliability, availability, serviceability, and configuration functionality (RASC functionality) of the system's physical resources. For example, in one embodiment of the present invention, a partition resource map may be used to monitor the characteristics of the system's physical resources, and therefore, certain physical resources may not be used because they are off-line, unplugged, or are not functioning correctly.

In the embodiment presented in FIG. 2, a partition resource map 210 may contain information relating to the physical location of a resource (PHYS), the virtual configuration of the resource (LOGL), the partition that a physical resource is associated with (PART), and additional information (STAT). Additional information may include physical status, logical status, partition status, or RASC functionality. Control of these resources may then be passed to the partition processors themselves within each partition. A console 110 may allow a first partition processor within a first partition to access a physical component in a second partition. Or, when a partition processor within one partition wants to access the physical resources of another partition, it can do so through the console 110, which acts as a conduit. This approach may be used with other forms of partitioning as well, such as hard partitioning and soft partitioning, to provide a whole range of options in terms of performance, granularity, and isolation. Soft partitioning may be either software based, firmware based, or kernel based. Furthermore, the peer-based approach need not preclude the selective sharing of resources between peers.

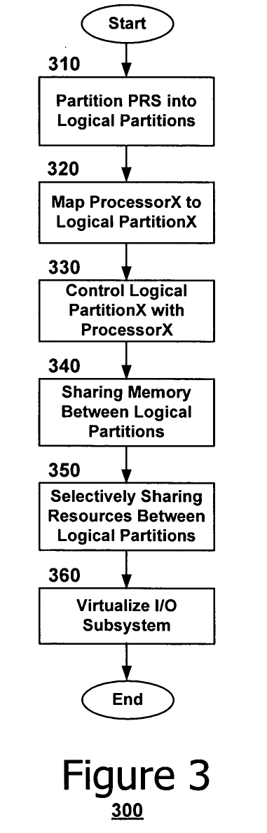

FIG. 3 illustrates in a flowchart one embodiment 300 of a method of partitioning a computer system into multiple virtual machines. The console 110 may partition a physical resource set (PRS) into logical partitions (Block 310). The console 110 may map a partition processor to each logical partition, so that a different partition processor is mapped to each logical partition (Block 320). Each partition processor would control its logical partition (Block 330). A partition processor may be mapped to control more than one partition. The console 110 may share memory between the logical partitions to implement high-speed communication between the logical partitions (Block 340). The console 110 may selectively share resources between the logical partitions (Block 350). One logical partition may virtualize an I/O subsystem to be used by other logical partition (Block 360).

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A method comprising:
partitioning a set of physical resources of a computer system into a set of logical partitions;
mapping a first partition processor to a first logical partition of the set of logical partitions;
controlling the first logical partition with the first partition processor;
mapping a second partition processor to a second logical partition of the set of logical partitions; and
controlling the second logical partition with the second partition processor.

2. The method of claim 1, wherein the first logical partition and the second logical partition have a master/slave configuration.

3. The method of claim 1, further comprising sharing memory to implement high-speed communication between the first logical partition and the second logical partition.

4. The method of claim 1 further comprising selectively sharing resources between the first logical partition and the second logical partition.

5. The method of claim 1, further comprising virtualizing an I/O subsystem with the first logical partition for use by the second logical partition.

6. The method of claim 1 wherein the partitioning is hard partitioning.

7. The method of claim 1 wherein the partitioning is soft partitioning.

8. The method of claim 1, further comprising maintaining information related to a status of a physical resource of the set of physical resources.

9. The method of claim 1, further comprising maintaining the partitioning and mapping information in a partition resource map.

10. A set of instructions residing in a storage medium, said set of instructions capable of being executed by a storage controller to implement a method for partitioning a computer system into more than one virtual machine, the method comprising:
partitioning a set of physical resources of a computer system into a set of logical partitions;
mapping a first partition processor to a first logical partition of the set of logical partitions;
controlling the first logical partition with the first partition processor;
mapping a second partition processor to a second logical partition of the set of logical partitions; and
controlling the second logical partition with the second partition processor.

11. The method of claim 10, wherein the first logical partition and the second logical partition have a master/slave configuration.

12. The method of claim 10, further comprising sharing memory to be used to implement high-speed communication between the first and the second logical partition.

13. The method of claim 10, further comprising selectively sharing resources between the first logical partition and the second logical partition.

14. The method of claim 10, further comprising virtualizing an I/O subsystem with the first logical partition for use by the second logical partition.

15. The method of claim 10, further comprising maintaining the partitioning and mapping information in a partition resource map.

16. A computer system comprising:
a first logical partition of a set of physical resources controlled by a first partition processor by maintaining a partition resource map listing physical resources associated with the first logical partition; and
a second logical partition of the set of physical resources controlled by a second partition processor.

17. The system of claim 16, wherein the first logical partition and the second logical partition have a master/slave configuration.

18. The system of claim 16, further comprising resources selectively shared between the first logical partition and the second logical partition.

19. The system of claim 16, wherein the first logical partition virtualizes an I/O subsystem for use by the second logical partition.

20. The system of claim 16, wherein the partition resource map maintains information related to a status of a physical resource of the set of physical resources.
